(19) United States
(12) Patent Application Publication
(10) Pub. No.: US 2014/0249695 A1
(43) Pub. Date: Sep. 4, 2014

(54) LOW LATENCY DATA LINK SYSTEM AND METHOD

(71) Applicant: RoboteX Inc., Sunnyvale, CA (US)

(72) Inventors: Adam M. GETTINGS, Red Wing, MN (US); Randy Wai TING, San Francisco, CA (US); Kito BERG-TAYLOR, Union City, CA (US); Joel D. BRINTON, Redwood City, CA (US); Taylor J. PENN, Mountain View, CA (US)

(73) Assignee: ROBOTEX INC., Sunnyvale, CA (US)

(21) Appl. No.: 14/188,575

(22) Filed: Feb. 24, 2014

Related U.S. Application Data
(60) Provisional application No. 61/771,758, filed on Mar. 1, 2013.

(51) Int. Cl. G05D 1/00

(52) U.S. Cl. CPC G05D 1/0022; Y10S 901/01; Y10S 901/47
USPC 701/2; 901/1; 901/47

(57) ABSTRACT

Devices and methods for a low latency data telecommunication system and method for video, audio control data and other data for use with one or more robots and remote controls are disclosed. The data transmission can be digital. The data telecommunication system can enable the use of multiple robots and multiple remote controls in the same location with encrypted data transmission.

### CROSS-REFERENCE TO RELATED APPLICATIONS

This application is a non-provisional of U.S. Patent Application No. 61/771,758 filed on Mar. 1, 2013, the content of which is incorporated herein by reference in its entirety.

### BACKGROUND OF THE INVENTION

1. Field of the Invention

Devices and methods for a low latency data telecommunication system and method are disclosed.

2. Description of the Related Art

Data transmissions to and from remote controlled devices, such as mobile robots, can suffer from time lags. This lag can be exacerbated when high data density transmissions are transmitted wirelessly, and the resulting signal may suffer from bandwidth degradation due to structural interference (e.g., transmitting through a wall) or at distant ranges. For example, the farther away a wireless remote controlled device gets from its operator, the more likely it is that bandwidth reductions occur due to signal loss.

FIG. 4 illustrates that robots with remote video transmission capabilities can typically have a first camera that would be connected to an analog radio. This robot system then broadcasts, via the analog radio, analog radio signals containing the video data captured by the first camera. The remote control's control unit system often contains an analog receiver and various other components including a display (collectively shown as the “OCU” in the figure). The analog signals broadcast by the robot system 28 are received by the analog receiver on the control unit system 34, establishing an analog data link 36 from the robot 2 to the control unit 4. The pure analog signal can degrade without an easy way to retain or regain resolution of the original signal. These analog signals also can not be readily encrypted for secure communication. The analog signal is also not directly compatible with digital networks. Furthermore, the robot system is fixed in that it can not be altered to add cameras.

Analog signals on the same frequency also interfere with each other. Therefore, multiple robots used in proximity with each other would need to be set to different frequencies, and each would need a separate control unit or a tunable control unit or else the signals will interfere.

In remote video transmission systems that transmit digital data, the delay between the remote system and the local control unit can be critical. Smooth and effective control of the robot is dependent on relatively instant video feedback from the robot to the controller, and similarly fast transmission of control signals from the controller to the robot. Without a very low latency of the complete transmission of the video from the time of video input into the camera on the robot until video output on the display of the control unit, control of the robot is far less precise and less efficient. Also, the operator experience is much more frustrating and less enjoyable. For example, for a robot with a low latency data link, the operator will provide a control signal to steer, accelerate or decelerate the robot, or operate a peripheral component on the robot, yet the robot will no longer be in the position indicated by the video signal received by the control unit because of the lag of the video signal.

Remote video transmission systems that use digital signals are capable of being reproduced by the operator's display only completely or not at all. There is no fade-out for digital transmissions similar to the slowly eroding signal and increasing static for an analog signal that is moving out of range. This lack of fade-out would be especially problematic when operating a mobile robot using a digital video transmission because the operator would have no warning that the robot is about to leave the range of the video transmission because the video displayed on the control unit will instantly change from being clear to having no image at all. The operator would therefore he left unaware of the robot's condition and environment, and also not be aware of the need to withdraw the robot back into range before the signal was lost.

Accordingly, a robot that utilizes a digital data link with a control unit is desired. Also, a remote digital video transmission system that can warn an operator before the signal is lost is desired. Also, a remote video transmission system that can produce a very low latency transmission is desired. Further, having a system capable of adding or removing cameras or robots (e.g., with robots) to the system while Maintaining a single control Unit is desired.

### SUMMARY OF THE INVENTION

A low latency link telecommunication system and method are disclosed. The system can wirelessly transmit video and/or audio data. The system can have a first robot, a second robot and a first remote control. The first robot can be configured to wirelessly transmit a first data stream on a first frequency. The second robot can be configured to wirelessly transmit a second data stream on the first frequency. The first remote control unit can be configured to receive the first data stream and/or the second data stream.

The system can have a second remote control unit configured to receive the second data stream. The first author second remote control units can be within a broadcast range of the first data stream and a broadcast range of the second data stream (i.e., the first and second broadcast ranges can overlap at the locations of one or more of the remote control units).

A video and/or audio wireless data transmission system is disclosed that can have a robot and a remote control unit. The robot can be configured to wirelessly transmit video and/or audio data over a digital data link with the remote control unit. The robot can be configured to encrypt the transmission of the video and/or audio and/or other data. The first remote control unit can be configured to unencrypt the transmission of data from the robot.

The robot can be configured to wirelessly transmit video data to the first remote control unit, where the first remote control unit can display the video data from the robot as a split-screen and/or picture-in-picture display.

The robot can have an expandable bus (e.g., USB) configured to receive more than one input device. A first camera, second camera, chemical sensors, environmental sensors (e.g., temperature, humidity, pressure, light), or combinations thereof can be connected to and disconnected from the expandable bus.

The robot can transmit the (e.g., video) data as a sequence of individual pixel packets or line-by-line packets.

The robot can vary the quality of compression of the data before transmission. The robot can reduce the compression when the transmission is in a low latency state, and increase the compression when the transmission is in a high latency state.

The robot can vary the frame rate of the video data during transmission. The robot can increase the frame rate when the transmission is in a low latency state, and reduce the compression when the transmission is in a high latency state. The robot can increase the frame rate when the robot and/or camera are in a fast motion state (i.e., moving at all or moving fast), and reduce the compression when the robot and/or camera are in a slow or no motion state. The motion state correlates to the speed and/or rate of rotation of the robot and/or camera.

The robot can have encoding hardware and a USB hub. The robot can encode, encrypt and/or compress the video data before sending the data to the USB hub. The USB hub can deliver the encoded, encrypted, and/or compressed video data to telecommunication transmission software and hardware to broadcast the video to the control unit.

The robot can drop or try to resend packets or frames that are not properly transmitted to the receiving control unit.

### BRIEF DESCRIPTION OF THE FIGURES

FIG. 1 illustrates a variation of a robot and control unit in data communication with each other.

FIG. 2 is a schematic drawing of a variation of a portion of the low-latency link data telecommunication system and a method of transmitting data therethrough.

FIG. 3 is a schematic drawing of a variation of the data telecommunication system.

FIG. 4 is not the invention and is a schematic drawing of a variation of a data telecommunication system.

FIGS. 5 through 8 are schematic drawings of variations of the data telecommunication system.

### DETAILED DESCRIPTION

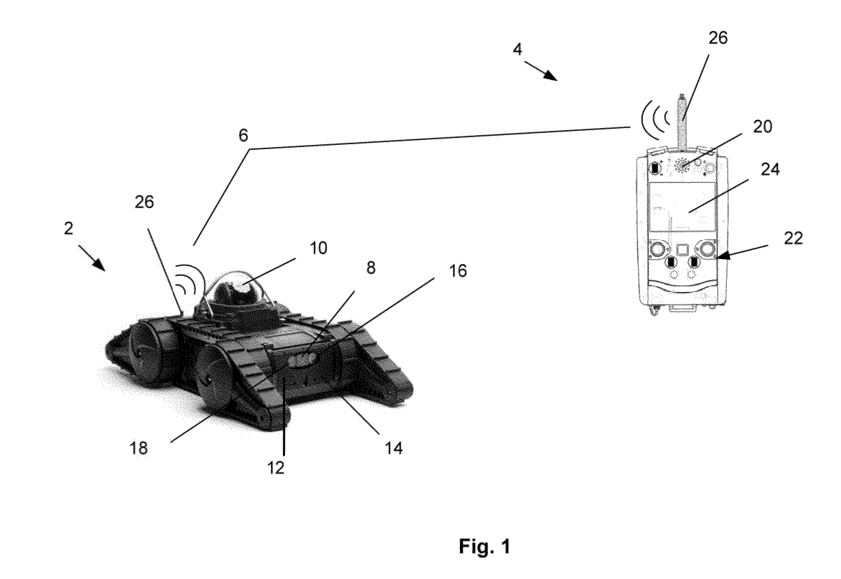

FIG. 1 illustrates that a robot 2 and control unit 4 (e.g., an operator controller unit, “OCU”) can communicate data over a wireless network, such as over a wi-fi data link 6. The robot 2 and control unit 4 can transmit data: video, audio, robot and control unit operational status data (e.g., battery level, component failures), position location data (e.g., latitude and longitude, area maps, building blueprints), directional data (e.g., steering instructions, directions for walking with the control unit 4 to reach the robot 2), environmental data (e.g., temperature, humidity, atmospheric pressure, brightness, time, date), hazardous chemical data (e.g., toxic chemical concentrations), or combinations thereof. The transmitted data can be digital, analog, or combinations thereof.

The robot 2 can have robot input elements, such as one or more robot video inputs (e.g., a first camera 8 and a second camera 10), robot audio inputs (e.g., a microphone 12), chemical and/or smoke sensors, environmental data inputs (e.g., thermometer, or combinations thereof. The robot 2 can have robot output elements, such as robot audio output elements (e.g., a speaker 14), robot video output elements (e.g., a visible light headlight 16, an infrared light 18, a high intensity strobe light, a projector, an LCD display), a chemical emission element (e.g., a flare, a smoke generator), or combinations thereof.

The robot 2 can be mobile. The robot 2 can have four flippers. Each flipper can have a track that can rotate around the flipper to move the robot 2. The flippers can articulate, for example rotating about the axes with which they attach to the robot body.

The robot input and/or output elements can have a fixed orientation with respect to the robot body or can be controllably oriented with respect to the robot body. For example, the robot 2 can have the first camera 8 mounted to the front face of the robot body in a fixed orientation with respect to the robot body. The second camera 10 can be mounted in a payload bay in the rear end of the robot body. The second camera 10 can be a 360° pan-tilt-zoom (PTZ) camera. The second camera 10 can extend above the top of the robot body. The second camera 10 can be covered by a transparent (e.g., plastic, plexiglass or glass) shell and/or one or more roll bars.

The control unit 4 can have control unit input elements, such as one or more control unit video inputs, control unit audio inputs (e.g., a microphone 20), control unit user input elements (e.g., buttons, blobs, switches, keyboards, or combinations thereof assembled in the control array 22), any of the input elements described for the robot 2, or combinations thereof. The control unit 4 can have control unit output elements, such as control unit audio output elements (e.g., a speaker, the speaker can be combined with the microphone 20) control unit video output elements (e.g., one or more displays 24, such as a color LCD display), or combinations thereof.

The control unit 4 and robot 2 can each have a radio antenna 26 extending from or contained within the respective structural bodies. The radio antenna 26 can be configured to be a wi-fi antenna. The radio antennas 26 on the control unit 4 and robot 2 can transfer radio transmission data between each other, for example forming a wi-fi data link 6 between the robot 2 and the control unit 4.

The electronics and software of the robot 2 can be known as a robot system 28.

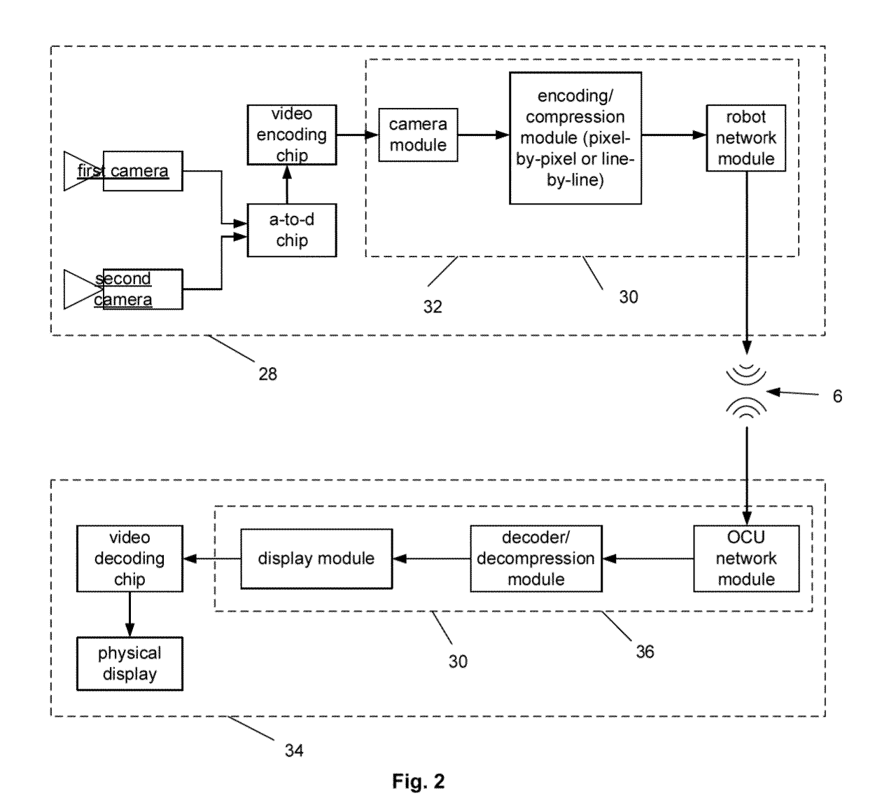

FIG. 2 illustrates that the electronics and software robot system 28 can have one or more robot inputs, such as the first camera 8 and the second camera 10. The first 8 and second 10 cameras can send analog video and/or audio data (e.g., if the cameras are combined with microphones or the data is audio and video is integrated) to an analog-to-digital (i.e., “a-to-d”) conversion chip. The a-to-d chip can be in the camera case or separate from the camera in the robot 2. The a-to-d chip can convert the analog signal(s) to digital signals by methods known to those having ordinary skill in the art.

The digital signal can be sent to a video encoding chip, for example to be encoded (e.g., MPEG encoding) or encrypted, or directly to a camera module on another processor 30 on the robot 2. If the signal is sent to the video encoding chip, the video encoding chip can encrypt or encode the signal, and then send the encoded or encrypted digital signal to the camera module on the processor 30.

Whether the video signal comes directly from the a-to-d chip or encrypted or encoded from the video encoding chip, the camera module can then receive and deliver the optionally encrypted digital video signal to the encoding/compression module. The encoding/compression module can receive signals from one or more input modules, for example the camera module, an audio module, a locomotion module, or combinations thereof. The audio module can deliver a digital audio signal from a microphone on the robot 2. The locomotion module can deliver a signal of data from feedback regarding the motion and directional orientation of the robot 2.

The encoding/compression module can compress and encode the video signal into line-by-line or pixel-by-pixel packets (or frame-by-frame packets). The encoding and compression module can optionally encrypt the compiled signal front the different modules. The encoding/compression module can send the packets to a robot network module.

The encoding/compression robot can interlace data from the different input modules, for example interlacing the video signal, audio signal, and locomotion signal with each other.

The robot network module can establish a wireless telecommunication data link 6 (e.g., an RF link, such as over wi-fi) with the control unit.

The encoding/compression module can send the data packets for the video signal to the robot network module line-by-line, pixel-by-pixel, or frame-by-frame, or combinations thereof. The robot network module can transmit using transmission control protocol (TCP) or user datagram protocol (UDP) communication protocols. If a packet or frame is improperly transmitted (i.e., missed or not properly received by the control unit) dining transmission, the robot network module can retransmit the missed packet or frame, or drop (i.e., not try to retransmit) the missed packet or frame (e.g., with UDP). For example, the robot network module can be configured to drop all missed packets, or to drop the oldest missed packets when the queue of packets to be retransmitted is over a desired maximum queue length. Dropping packets or frames, rather than queuing packets or frames for retransmission, can reduce data transmission lag.

The input modules (e.g, the camera module, the audio module, the locomotion module), the encoding/compression module and robot network module can comprise the software architecture 32 executing on one or more processors 30 on the robot 2.

The electronics and software control unit system 34 can have one of more processors 30 that execute a software architecture 36 to receive and process the received digital video signal (and other signals interlaced with the video).

The wireless radio telecommunication signal from the robot system 28 can be initially processed by an OCU network module. The OCU network module can receive the data packets from the robot network module and communicate to the robot network module, for example to confirm receipt of data packets. The OCU network module can send the received data signal to the decoder/decompression module.

The decoder/decompression module can receive the digital signal from the OCU network module and decode, decompress and decrypt, if necessary, the signal.

The control unit can have one or more output modules within the software architecture 36. For example, the control module can have a display module, a speaker module, a locomotion output module, or combinations thereof. The encoding/compression module can route data from the signals to the respective output module, for example sending the audio signal to the speaker module, the locomotion signal to the locomotion output module, and the video signal to the display module.

The decoder/decompression module can reassemble the video frames from the line-by-line or pixel-by-pixel data, or the display module can reassemble the video frames.

The display module can send the video signal data to a video decoding chip or, if the video data is not encrypted or encoded after passing through the decoder/decompression module, the display module can send the video signal data directly to the physical display. The display module can include a driver to display the video signal data on the physical display.

The video decoding chip can decrypt the video signal data and send the decrypted video signal data to the physical display.

The physical display can be, for example, an LCD, plasma, LED, OLED display, or a combination of multiple displays.

The output modules (e.g, the display module, the speaker module, the locomotion output module), the encoding/compression module and robot network module can comprise the software architecture 32 executing on one or more processors 30 on the robot 2.

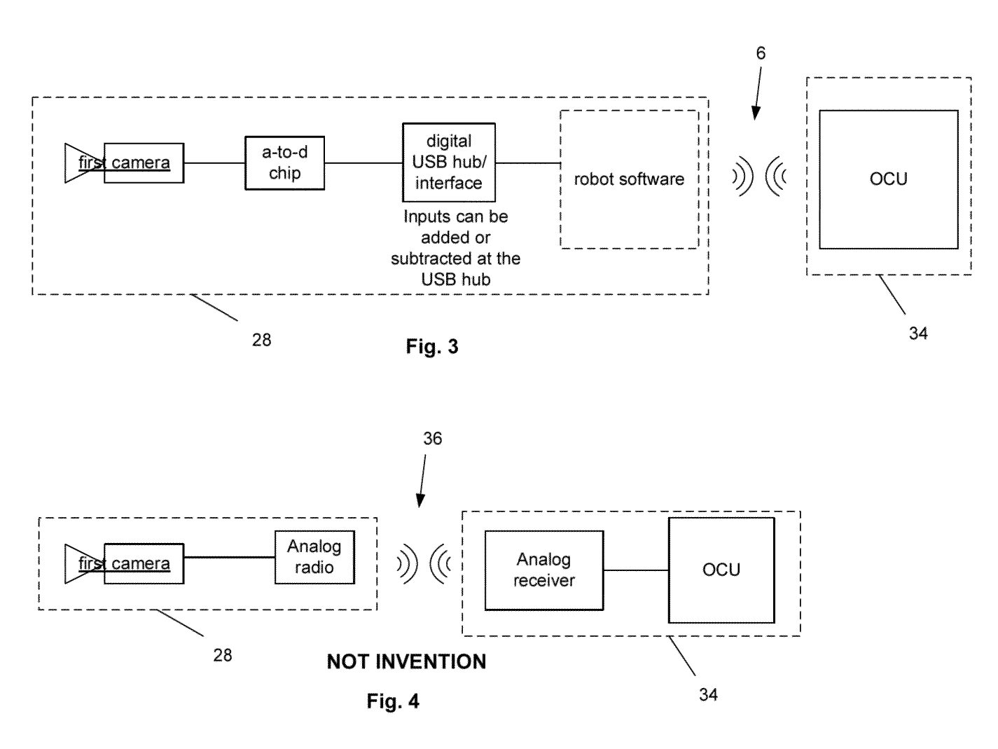

FIG. 3 illustrates that the robot system 28 can have a first camera that can be connected to an a-to-d processor/chip. The a-to-d chip can be connected to (e.g., removably plugged into) a digital USB huh or interface. Other inputs can be attached to or removed from the USB hub, for example, additional cameras, microphones, chemical, temperature, humidity or radiation detection apparatus, speakers, strobe or flashlights, or combinations thereof. The USB hub can be connected to the robot software.

The data telecommunication system 40 can include the robot system 28 and the OCU connected over a digital wireless data link 6 as described herein (e.g., wifi). The robot system 28 can transmit data to the OCU from any of the components attached to the USB hub and receive data from the OCU for any of the components attached to the USB hub.

The robot software can communicate the status of all of the USB hub components to the OCU.

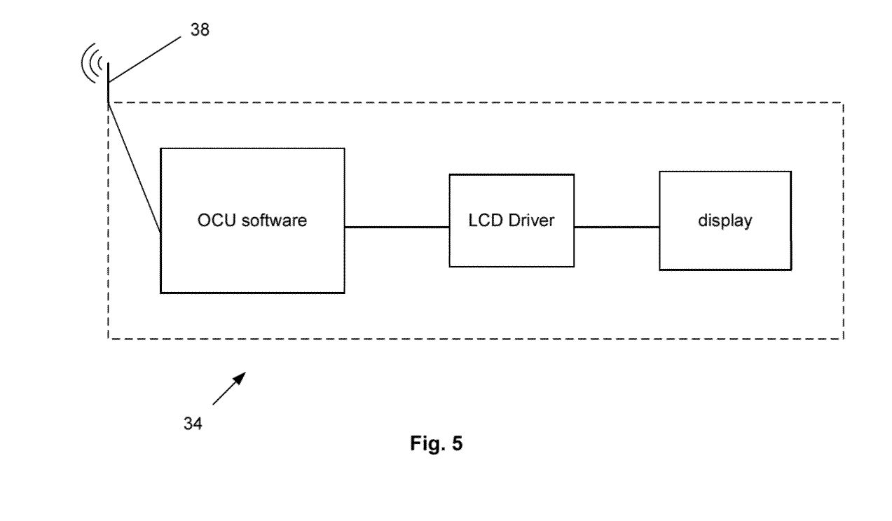

FIG. 5 illustrates that the control unit system 34 can have OCU software that can send display data to a display driver software and/or hardware, and a display, such as an LCD. The display can be a touchscreen display and can send data to the OCU software.

The OCU software can receive digital and/or analog data through an antenna 38.

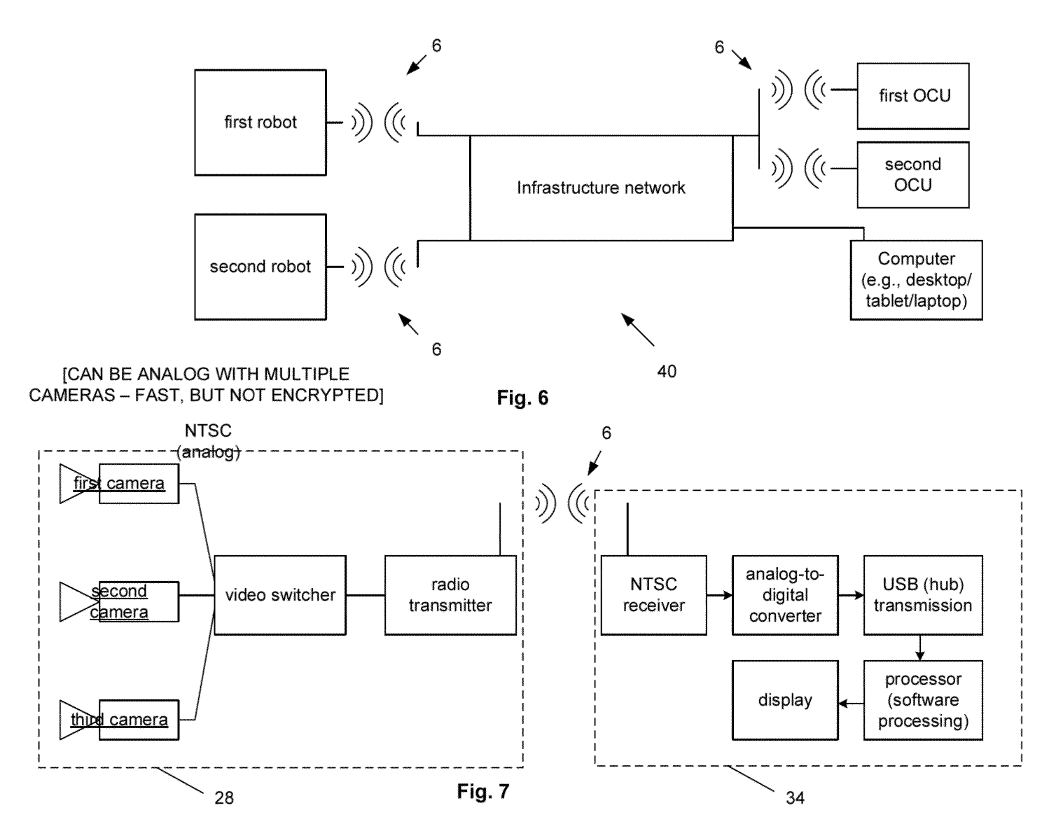

FIG. 6 illustrates that a telecommunication system 40 can have more than one robot, such as a first robot and a second robot. The telecommunication system 40 can have one or more OCUs. The telecommunication system 40 can have an infrastructure network such as a wired and/or wireless LAN within a building (e.g., a building wifi network), the internet, or a company network (e.g., across a campus of one or more buildings or multiple campuses), or combinations thereof. The infrastructure network can have one or more wireless access points that can be in data communication with the robots and/or the OCUs. The infrastructure network can be connected in wired or wireless data communication to one or more computers, such as desktops, laptops, tablets, smartphones, or combinations thereof.

The robots can be attached to each other or move independent of each other. Each robot can communicate directly with one or more OCUs and/or directly with infrastructure network. The infrastructure network can communicate directly with the OCUs. The data links 6 between the robots, the infrastructure network and the OCUs can be digital links as described herein (e.g., wifi).

For example, the first and second robots can send data to and receive data from the infrastructure network. The computer(s) can receive, process and view the data from the first robot and the second robot. The computer can control the robots, and/or assign one of the OCUs to control each robot and/or assign one OCU to control multiple robots. The computer can send the respective OCU all or some of the data from the robot which the OCU is assigned to control.

The computer can re-assign the OCUs during use to a different robot or add or remove robots from each OCU's control. The computer can override commands sent by the respective OCU to the respectively-controlled robot. The computer can record data (locally or elsewhere on the network, such as to a hard drive) from the robots and/or from the OCUs.

The computer can be connected to one or more visual displays (e.g., LCDs). Each display connected to the computer can show data from one or more of the robots so a user of the computer can simultaneously observe data from multiple robots.

The signals between the robots and the infrastructure network, and/or between the OUCs and the infrastructure network can be encrypted.

The computer can be located proximally or remotely from the robots and/or OCUs. For example, the robots can be patrolling a first building, the computer can be located in a second building, and the OCUs can be located in the first building or in multiple other locations.

The computer can transmit data to or receive from the OCUs not originating from or received by the robots, and/or the computer can transmit data to or receive data from the robots not originating from the OCUs. For example, the operator of the computer can send and receive audio signals (e.g., having a private discussion with one or more of the operators of the OCUs) to one or more of the OCUs that is originated at the computer and not sent to the robots.

The computer can process data from the OCU and/or robot before transmitting the data to the other component (e.g., the robot and/or OCU, respectively). For example, the computer can perform face recognition analysis on the video signal from the robot. Also for example, the computer can send autonomous driving instructions (e.g., unless overridden by manual instructions from the OCU or computer's user input) to the robot to navigate a known map of the respective building where the robot is located to reach a desired destination.

FIG. 7 illustrates that the robot system 28 can have multiple cameras such as a first camera, second camera, and third camera. The cameras can be analog cameras. The cameras can transmit an analog (e.g., National Television System Committee (NTSC) format) signal to a video switcher in the robot system 28. The video switcher can transmit a selected camera's signal to an analog radio transmitter in the robot system 28. The camera to be used can discretely controlled (e.g., manually selected by instructions sent from the control system or from autonomous instructions programmed on a processor 30 in the robot system 28) or constantly rotated (e.g. selecting 0.1 seconds of signal per camera in constant rotation between the cameras).

The radio transmitter can send analog video (and audio if included) data signals to the control system, for example to an NTSC receiver in the control system. The transmitted analog video can be unencrypted. The NTSC receiver can send the received signal to an a-to-d converter in the control system. The a-to-d converter can convert the received analog signal to a digital video and audio if included) signal.

The a-to-d converter can be connected to (e.g., plugged into) a USB hub. Other components, such as digital receivers receiving digital (encrypted or unencrypted) signals from the robot system 28 can be connected to the USB hub. The USB hub deliver all of the digital data received by the USB hub (e.g., the converted video and audio, as well as separately-transmitted digital data) to a processor 30 for additional software processing including video processing, and resulting video data can be transmitted to the OCU's display.

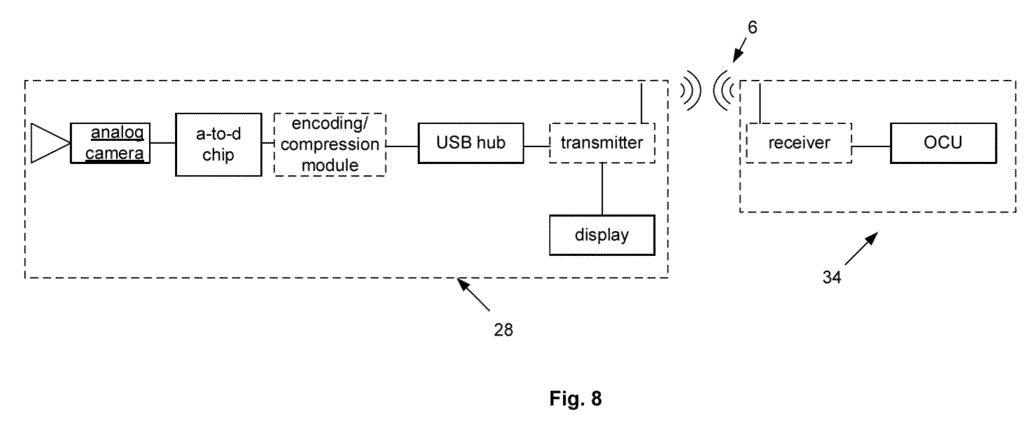

FIG. 8 illustrates that the robot system 28 can send the digitally-converted video signal from an a-to-d chip to hardware and/or software to perform the encoding and compression before the data is delivered through a USB hub on the robot.

Each robot can send data signals to one or more: OCUs or network infrastructures.

The transmission (e.g., wifi) frequency used by each robot can be changed by swapping out the radios on the robot and/or having multiple hardware radios on board each robot and switching between the multiple radios with frequency-controlling software. For example, if the first frequency's bandwidth becomes crowded and interference occurs, the frequency-controlling software (or a manual signal from the OCU or inputted directly into the robot) can select a difference hardware radio that can communicate on a second frequency.

Infrastructure networks can be configured to be controlled to prioritize robot and OCU data transmission over other data (e.g., office VOIP telephone conversations, web browsing not to or from the OCU or robot), for example to reduce lag.

The system (e.g., processors on the robot, OCU, computer, or combinations thereof) can have a dynamic frame transmission rate, for example to minimize latency For example, the system can reduce frame rate transmission as latency increases, and increasing frame rate transmission as latency decreases.

The system can have a dynamic compression quality. For example, the system can reduce compression when latency increases and can increase compression When latency increases. Frame rate and compression changes can be performed in conjunction or independent of each other.

The system can control the transmission frame rate and/or compression based on the robot motion and/or camera motion (e.g., by measuring zoom, camera pan-tilt-zoom motor, robot track speed, accelerometers, or combinations thereof). For example, the system can transmit about 30 frames per second (fps) (e.g., NTSC is 29.97 fps) at a higher compression when the robot or camera are moving and about 15 fps at a lower compression when the robot and camera are stationary.

The robot processor 30 can process the image into black and white, a wire frame image, reduced imagery replacing objects with boxes and spheres), or combinations thereof, for example to reduce the video data transmission size and latency.

The robot, and/or OCU, and/or computer, can have a pre-loaded map and/or rendering of a site location of the robot (e.g., a building floorplan). The robot can transmit a location of the robot relative to the map and/or rendering to the OCU and/or computer. The robot can transmit a partial video feed with the location of the robot to the OCU and/or computer. For example, the partial video feed can be images of Objects near the robot; and/or objects that do not appear in the floorplan or rendering; and/or video around a tool attached. to the robot, such as a gripper; and/or the robot can send a highly compressed image and the OCU or computer can select discrete objects in the image to transmit or retransmit at lower compression (e.g., higher resolution).

The robot system 28 can have image processing software and/or hardware that can identify identifying information (e.g., numbers, letters, faces) in the video and blur autonomously or manually selected identifying information (e.g., just text, but not faces) before transmission, for example for security and to transmit less data and reduce transmission latency.

Multiple robots and/or OCU can transmit on the same frequency. The transmitted signals can be encrypted or encoded. Multiple video streams, for example displayed as split screen or picture-in picture, can be transmitted from one or more robots to one or more OCUs or vice versa.

Optimized types of cameras can be attached to the robots (e.g., via USB connections) depending on the expected use. For example, CCD, CMOS, infrared (IR) cameras, or combinations thereof, can be connected to or removed from the robot, such as by plugging or unplugging the cameras into the USB ports on the robot.

The robot and control units (e.g., OCUs) herein can be the robots, or elements thereof, described in U.S. Pat. No. 8,100,205, issued 24 Jan. 2012, and/or U.S. Provisional Application No. 61/586,238, filed 13 Jan. 2012, both of which are incorporated by referenced herein in their entireties.

The compression, encoding, decoding and other transmission-related methods described herein as being performed by the robot, the OCU, the infrastructure network or the computer can be performed by the other components (e.g., the other of the robot, the OCU, the infrastructure network or computer) described herein.

It is apparent to one skilled in the art that various changes and modifications can be made to this disclosure, and equivalents employed, without departing from the spirit and scope of the invention. Elements of systems, devices and methods shown with any embodiment are exemplary for the specific embodiment and can be used in combination of otherwise on other embodiments within this disclosure.

We claim:

1. A video and/or audio wireless data transmission system comprising:
a first robot configured to wirelessly transmit a first data stream on a first frequency;
a second robot configured to wirelessly transmit a second data stream on the first frequency;
a first remote control unit configured to receive the first data stream.

2. The system of claim 1, wherein the first remote control unit is configured to receive the second data stream.

3. The system of claim 1, further comprising a second remote control unit configured to receive the second data stream.

4. The system of claim 1, wherein the first remote control unit is within a broadcast range of the first data stream and a broadcast range of the second data stream.

5. A video and/or audio wireless data transmission system comprising:
a first robot: and
a first remote control unit;
wherein the first robot is configured to wirelessly transmit video data over a digital data link with the first remote control unit.

6. The system of claim 5, wherein the first robot is configured to wirelessly transmit audio data over the digital data link with the first remote control unit.

7. The system of claim 5, wherein the first robot is configured to encrypt the transmission of video data.

8. The system of claim 7, wherein the first remote control unit is configured to unencrypt the transmission of video data.

9. A video and/or audio wireless data transmission system comprising:
a first robot; and
first remote control unit;
wherein the first robot is configured to wirelessly transmit video data to the first remote control unit, wherein the first remote control unit is configured to display the video data from the first robot comprising a split-screen and/or picture-in-picture display.

10. A video and/or audio wireless data transmission system comprising:
a first robot configured to broadcast a data signal, the first robot comprising an expandable bus (e.g., USB) configured to receive more than one input device;
a first input device connected to the expandable bus; and
a second input device connected to the expandable bus.

11. The system of claim 10, wherein the first input device comprises a first camera.

12. The system of claim 10, wherein the first input device comprises a chemical sensor.

13. The system of claim 10, wherein the first input device comprises an environmental sensor.

14. The system of claim 11, wherein the second input device comprises a second camera.

15. A video and/or audio wireless data transmission system comprising:
a robot configured to wirelessly transmit digital video data as a sequence of packets; and
a remote control configured to receive the video data and
wherein the packets comprise at least one of pixel packets or line-by-line packets.

16. A video and/or audio wireless data transmission system comprising:
a robot configured to compress and wirelessly transmit data, wherein the robot is configured to vary the quality of the compression.

17. The system of claim 16, wherein the robot is configured to reduce the compression when the transmission is in a low latency state, and wherein the robot is configured to increase the compression when the transmission is in a high latency state.

18. A video and/or audio wireless data transmission system comprising:
a robot configured to wirelessly transmit video data, wherein the robot is configured to vary a frame rate of the video data during transmission.

19. The system of claim 18, wherein the robot is configured to increase the frame rate when the transmission is in a low latency state, and wherein the robot is configured to reduce the compression when the transmission is in a high latency state.

20. The system of claim 18, wherein the robot is configured to increase the frame rate when the robot is in a fast motion state, and wherein the robot is configured to reduce the compression when the robot is in a slow or no motion state.

21. The system of claim 20, wherein the motion state of the robot correlates to the speed. and/or rate of rotation of the robot.

22. A video and/or audio wireless data transmission system comprising:
a robot configured to wirelessly transmit video data, wherein the robot comprises video encoding hardware and a USB hub, and wherein the robot is configured so the video encoding hardware sends the video data to the USB hub.

23. A video and/or audio wireless data transmission system comprising:
a robot configured to wirelessly transmit video data, wherein the robot is configured to drop frames that are not properly transmitted.
